(19) United States
(12) Patent Application Publication
(10) Pub. No.: US 2013/0073465 A1
(43) Pub. Date: Mar. 21, 2013

(54) MERCHANT STRUCTURE HIERARCHIES FOR MEDIATING TRANSACTION DATA ACCESS

(71) Applicant: Jeff Richey, Woodinville, WA (US)

(72) Inventor: Jeff Richey, Woodinville, WA (US)

(21) Appl. No.: 13/624,787

(22) Filed: Sep. 21, 2012

Related U.S. Application Data
(60) Provisional application No. 61/537,448, filed on Sep. 21, 2011.

(51) Int. Cl. G06Q 20/40; G06Q 20/22

(52) U.S. Cl. 705/44; 705/39

(57) ABSTRACT

Mediation hierarchies may be established and maintained for use in accessing and managing transaction data. The hierarchies may correspond to merchant organizational structures. The transaction data may include financial transactions, such as payment transactions facilitated by portable consumer devices including credit, debit and charge cards, that are made by customers of the merchant. The hierarchies may be used to mediate reporting, searching and decision management functionality with respect to the transaction data. Users may make requests with respect to transactions associated with one or more portions of a hierarchy. Transaction data access control may be associated with hierarchy nodes. Merchant organizational structures may change over time, and a history may be maintained for each mediation hierarchy. Transaction processing functionality associated with time intervals during which multiple hierarchy versions were active may be processed with respect to the active hierarchy version for each sub-interval.

### CROSS-REFERENCE TO RELATED APPLICATIONS

This application claims the benefit of U.S. Provisional Application No. 61/537,448, entitled “Merchant Structure Hierarchies for Mediating Transaction Data Access,” filed on Sep. 21, 2011, which is herein incorporated by reference in its entirety.

### TECHNICAL FIELD

This invention pertains generally to information processing and, more particularly, to information processing that involves transactions.

### BACKGROUND

It has become common for customers of merchants to pay for goods and services with cashless transactions such as payment transactions facilitated by portable consumer devices including credit, debit and charge cards. From the merchant point of view, such transactions involve complications but can also offer opportunities. For example, there may be an authorization process associated with the payment transaction. The authorization process is desirable for a wide variety of reasons, but a practical result is that such a transaction can enter a number of states requiring a resolution process before being approved. As the number of transactions grows large, efficiency in performing the resolution process can become a significant challenge. Such transactions also typically include or reference data about the customer purchase that can be valuable to the merchant when suitably extracted, analyzed and/or presented. However, again, as the number of transactions grows large, some conventional systems and methods have problems achieving sufficient efficiency, effectiveness and/or flexibility to enable consistently high value transaction data information production. Some conventional systems and methods have problems coping with the complexity and/or dynamic nature of the organizational structures of modern merchants.

Embodiments of the invention are directed toward solving these and other problems individually and collectively.

### BRIEF SUMMARY

Transaction data access may be mediated with merchant structure hierarchies. A method for such mediation may include maintaining one or more merchant structure hierarchies that reference a set of merchant locations that participate in the generation of a set of transaction data. The merchant structure hierarchies may be specified with a user interface such as a graphical user interface. A request for information with respect to the set of transaction data may be received. The request may include an indication of one or more nodes of the merchant structure hierarchy. A subset of the transaction data associated with the indicated node(s) may be determined. A response to the request may be provided. The response may be based on the determined subset of the transaction data.

The merchant structure hierarchy may reference a set of users. Such users may be authenticated. It may be determined whether one or more of the set of users is authorized with respect to the indicated node(s). The response to the request may be provided on condition that one or more of the set of users is so authorized. The request may include an indication of an interval of time. One or more versions of the merchant structure hierarchy that were active during the indicated interval of time may be determined. The subset of the transaction data upon which the response is based may be mediated by each of the versions of the merchant structure hierarchy that were active during the indicated interval of time, for example, one or more historical versions as well as a current version. Methods for such mediation may be performed by suitably configured components of a system and/or by computer-executable instructions stored on a computer-readable medium and executed by one or more computers.

This Brief Summary is provided to introduce a selection of concepts in a simplified form that are further described below in the Detailed Description. This Brief Summary is not intended to identify key or essential features of the claimed subject matter, nor is it intended to be used as an aid in determining the scope of the claimed subject matter. Other objects and/or advantages of the present invention will be apparent to one of ordinary skill in the art upon review of the Detailed Description and the included figures.

### BRIEF DESCRIPTION OF THE DRAWINGS

Various embodiments in accordance with the present disclosure will be described with reference to the drawings, in which:

FIG. 1 is a schematic diagram depicting aspects of an example computing environment in accordance with at least one embodiment of the invention;

FIG. 2 is a schematic diagram depicting aspects of an example hierarchically mediated transaction data component in accordance with at least one embodiment of the invention;

FIG. 3 is a schematic diagram depicting an example merchant structure hierarchy in accordance with at least one embodiment of the invention;

FIG. 4 is a flowchart depicting example steps for mediating transaction data access in accordance with at least one embodiment of the invention;

FIG. 5 is a flowchart depicting further example steps for mediating transaction data access in accordance with at least one embodiment of the invention; and

FIG. 6 is a schematic diagram depicting aspects of an example computer in accordance with at least one embodiment of the invention.

Note that the same numbers are used throughout the disclosure and figures to reference like components and features.

### DETAILED DESCRIPTION

In accordance with at least one embodiment of the invention, one or more hierarchies (at times referenced as “mediation hierarchies” herein) may be established and maintained for use in accessing and managing transaction data. The hierarchies may correspond to merchant organizational structures. For example, the root node of a hierarchy may correspond to a business entity of the merchant, the leaf nodes of the hierarchy may correspond to locations at which merchant-related transactions occur, such as physical retail locations and web sites, and intermediate nodes or layers may correspond to organizational units of the merchant, such as geographic regions. The transaction data may include financial transactions, such as payment transactions facilitated by portable consumer devices including credit, debit and charge cards, that are made by customers of the merchant. The hierarchies may be used to mediate reporting, searching and decision management functionality with respect to the transaction data. As used herein, the term “decision management” refers to the processes involved in transaction approval (e.g., the approval decision).

Hierarchies may include one or more sub-hierarchies (also called “sub-trees” herein), and transactions may be associated with one or more nodes in one or more of the sub-hierarchies. For example, each transaction may be associated with a leaf node of a hierarchy corresponding to a merchant location at which the transaction occurred and, in accordance with the hierarchy, may be associated with each sub-hierarchy (e.g., corresponding to a geographic region) that contains the leaf node. Users may make requests with respect to transactions associated with one or more portions of a hierarchy. For example, users may request a reporting, searching and/or decision management process with respect to a particular merchant structure organizational unit and/or its sub-units to any suitable granularity.

Transaction data access control may be associated with hierarchy nodes. For example, hierarchy nodes may reference access control lists that specify access rights with respect to the node and/or a sub-tree of which the node is a root node. In accordance with at least one embodiment of the invention, a hierarchy may mediate access to transaction data at least in part by limiting access by a user to transactions and/or transaction processing functionality associated with a set of nodes of the hierarchy for which the user has been authorized. For example, one particular user may be authorized for a node associated with Californian transactions, while another user is authorized for a sub-tree corresponding to the entire United States and including node corresponding to the California organizational unit. User authorizations may be different with respect to different hierarchies and/or sets of transaction processing functionality. For example, a user may have authorization to produce reports for the entire United States, but have ad hoc search capabilities only for California. Another user may have authorization to control decision management processes associated with Californian transactions, while having no authorization to produce high level reports and/or conduct ad hoc searches.

Merchant organizational structures may change over time. In accordance with at least one embodiment of the invention, a history may be maintained for each mediation hierarchy. For example, the history may include data enabling determination of previous versions of the mediation hierarchy, as well as the corresponding time intervals during which the previous versions acted as the most recent or current version (“were active”). In accordance with at least one embodiment of the invention, transaction processing functionality associated with time intervals during which multiple hierarchy versions were active may be processed with respect to the active hierarchy version for each sub-interval. For example, suppose a hierarchy that mediates reporting functionality with respect to transaction data (a “reporting hierarchy”) is modified mid-year. An annual report may be generated in accordance with the earlier version of the hierarchy for transactions that occurred in the first half of the year and in accordance with the later version of the hierarchy for transaction that occurred in the second half of the year.

In accordance with at least one embodiment of the invention, one or more hierarchical data structures may be built around a merchant's organization structure, the merchant's financial transaction data may be organized into, and/or associated with, the one or more hierarchical data structures, and one or more user interfaces and/or tools may be provided that enable users to leverage the organized transaction data for purposes including financial reporting, searching and decision management.

For example, for the purpose of geographically tracking its sales performance, a merchant may be organized into a three-level structure, where the first level consists of sales for Asia and Europe, the second level consists of sales for individual countries within Asia and Europe, and the third level consists of sales for specific regions within the individual countries. According to this example, the invention involves creating a three-level hierarchical data structure that matches the merchant's three-level organizational structure and then mapping the levels of the hierarchical data structure to the levels of the merchant's organizational structure. Here, the first level of the hierarchical data structure is mapped to sales for Asia and Europe, the second level of the hierarchical data structure is mapped to sales for the individual countries within Asia and Europe, and the third level of the hierarchical data structure is mapped to sales for specific regions within the individual countries. For example, East Germany is a specific region (third level) within Germany (second level), which is an individual country within Europe (first level).

Once the hierarchical data structure is created for the merchant, the merchant's transaction data may be organized into, and/or associated with, the hierarchical data structure. Next, users may access user interfaces and/or tools that are configured to leverage the organized transaction data for purposes including reporting, searching, and decision management. Referring to the example above, for financial reporting, a user (e.g., a sales manager of a merchant) may access the user interfaces/tools to generate financial reports that show the merchant's sales data by region, country, and/or continent. For example, a user may generate a report that shows Q1 2011 sales information for the merchant's East German stores. Such reports may be partitioned by transaction date/type, geographic location, card used, etc.

A merchant's transaction data can be organized into multiple hierarchical data structures as opposed to only one. For example, additional data structures may be provided to enable third parties to access the merchant's data. A merchant may have its own hierarchical data structure (e.g., per store, per region) that it uses for internal purposes, whereas a payment processor may organize the same merchants data into a different hierarchical structure (e.g., per payment processor, per payment type, per transaction date) for administrative purposes and/or decision management. For example, if there is an issue with the settlement of a particular transaction and the merchant asks the payment processor intervene and provide support for the transaction, the payment processor may use its own hierarchical data structure that it created on behalf of the merchant to search for and locate the particular transaction in question. This will enable payment processor to gather enough information about the transaction to enable payment processor to help facilitate settlement of the transaction.

Privileges and/or access rights may be assigned to individual users and/or groups of users, where the privileges/access rights specify which levels within the hierarchies of the data structures that the individuals and/or groups can access. For example, a regional manager's access may be restricted to just transaction data for a particular region, whereas a national manager may be permitted to access transaction data across all regions in a nation.

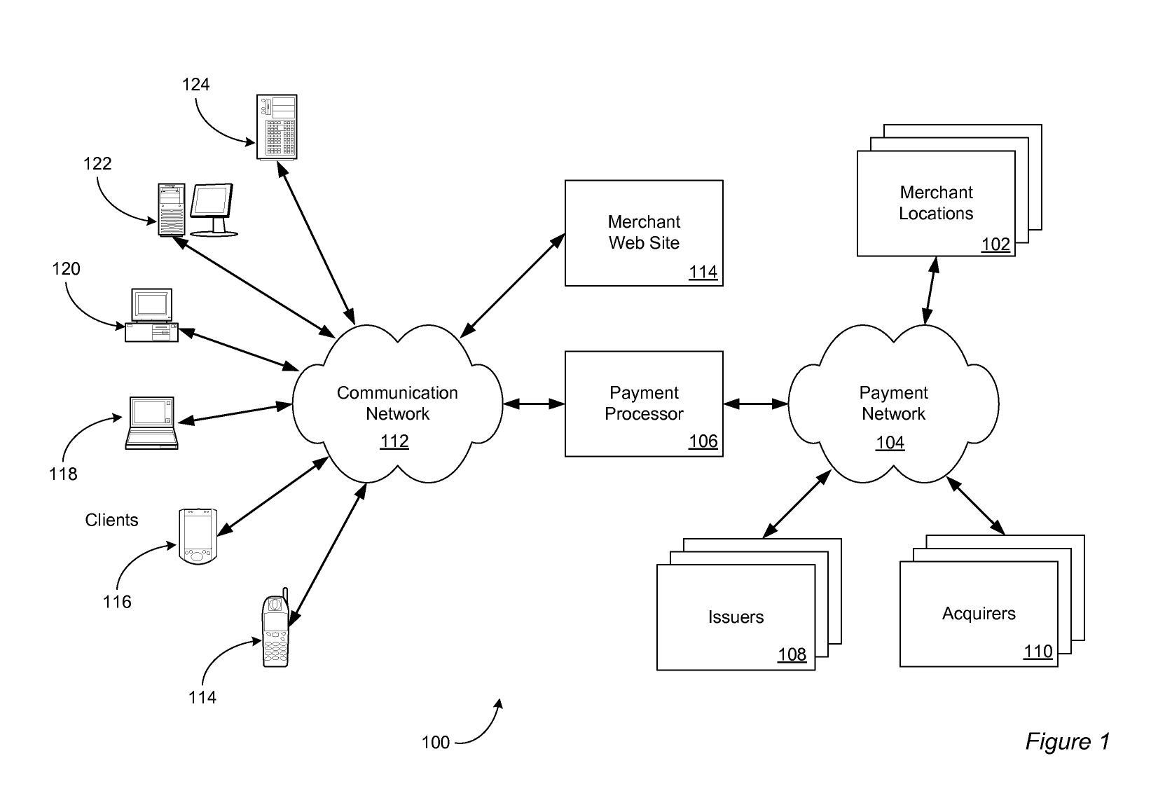

Various embodiments of the invention may incorporate, or be incorporated by, various computing environments. FIG. 1 depicts aspects of an example computing environment 100 in accordance with at least one embodiment of the invention. The computing environment 100 includes multiple merchant locations 102 communicatively connected with a payment network 104. A payment processor 106 may facilitate cashless transactions, such as payment transactions facilitated by portable consumer devices including credit, debit and charge cards, between consumer-associated accounts maintained by issuers 108 such as issuing banks and merchant-associated accounts maintained by acquirers 110 such as acquiring banks

The payment processor 106 may maintain a database of facilitated transactions for purposes including reporting, searching and decision management. In accordance with at least one embodiment of the invention, the payment processor 106 may provide mediated access to transaction data by one or more authorized users. In this example environment, the payment processor 106 is communicatively couple with a communication network 112 such as a public data network, and authorized users may access the mediated transaction data with clients 114, 116, 118, 120, 122, 124 that are also communicatively coupled with the communication network 112.

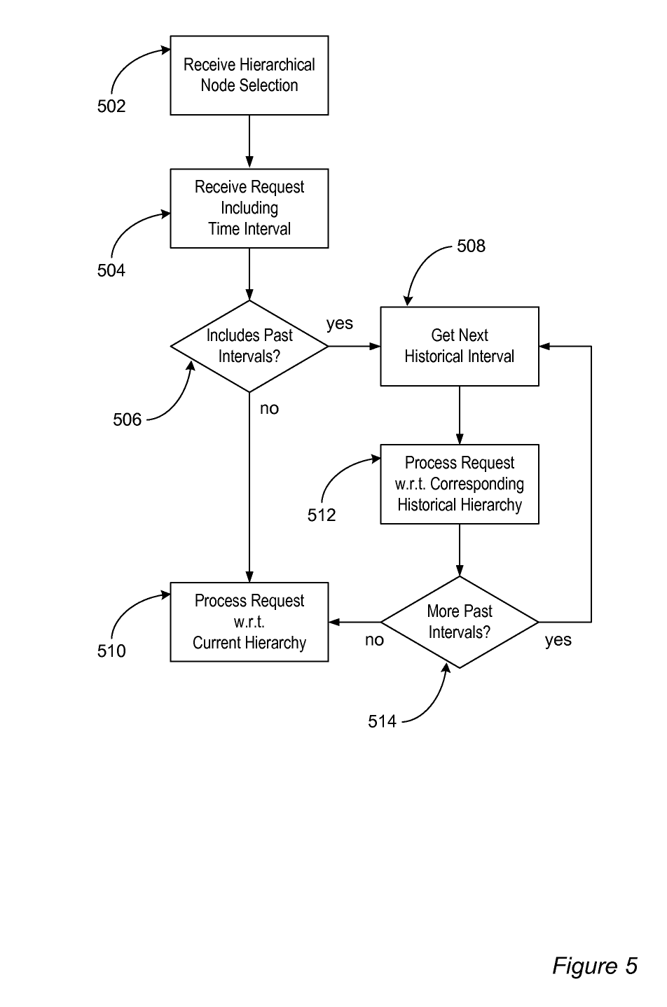

In the example environment 100, the communication network 112 and the payment network 104 are shown as logically distinct. In accordance with at least one embodiment of the invention, the two may overlap (including completely). For example, the communication network 112 may be the public internet, and the payment network 104 may be implemented at least in part with virtual private network and/or encrypted communication connections through the communication network 112. The environment 100 may incorporated and/or be implemented by any suitable computing device and/or network device. The networks 104, 112 may employ wireless communication techniques including wireless data and wireless telephony, as well as wired communication techniques including techniques that employ electric and optical signaling. An example computing device is described below in more detail with reference to FIG. 5.

Each of the merchant locations 102 may include one or more computing devices configured to facilitate and/or participate in payment transactions such as merchant terminals, point-of-sale terminals and/or suitably configured computers. Merchant locations 102 need not correspond to physical locations. For example, users may initiate transactions while interacting with a merchant web site 114. The payment processor 106 may facilitate such transactions. In at least one embodiment of the invention, merchant web sites such as the merchant web site 114 operate as merchant locations such as the merchant locations 102. Merchant web sites may have a geographical association, for example, an intended geographical service area. Merchant web sites may be implemented at least in part by one or more computers having a physical location, however, the physical location of such computers need not correspond to the primary geographical association of the merchant web site.

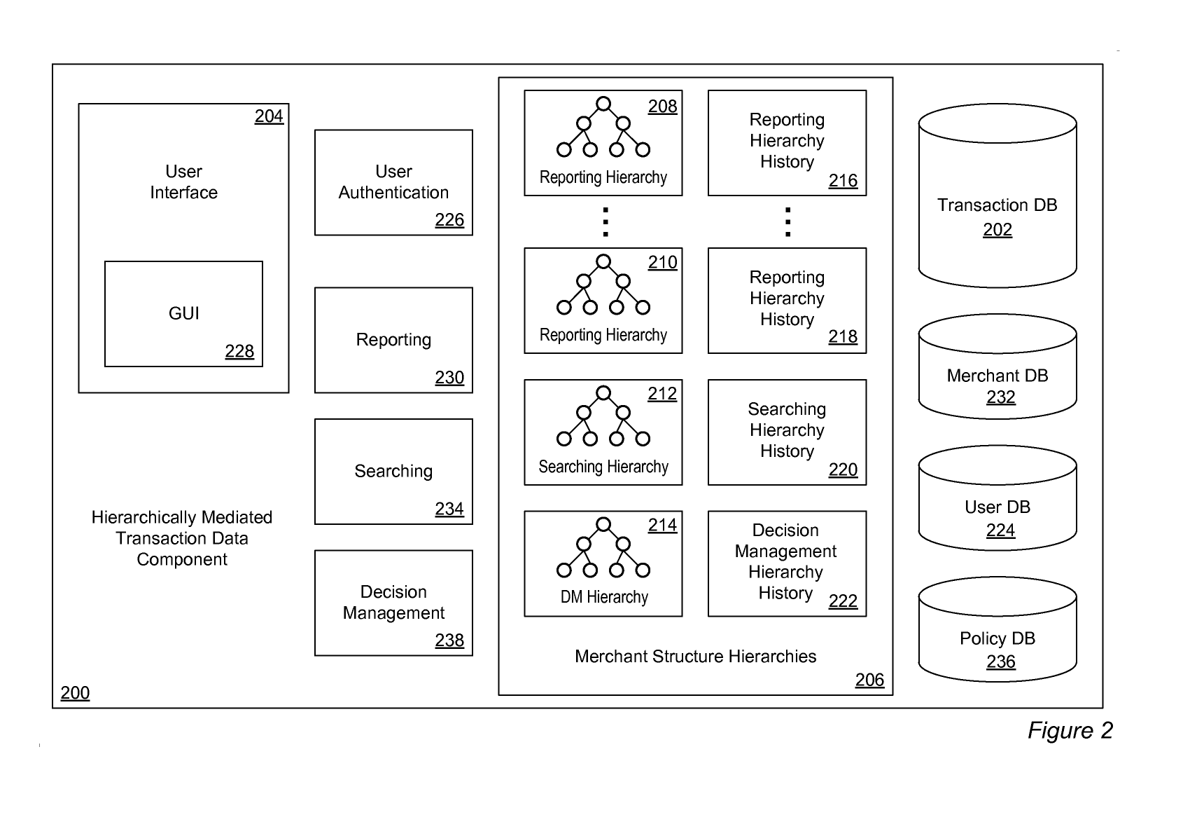

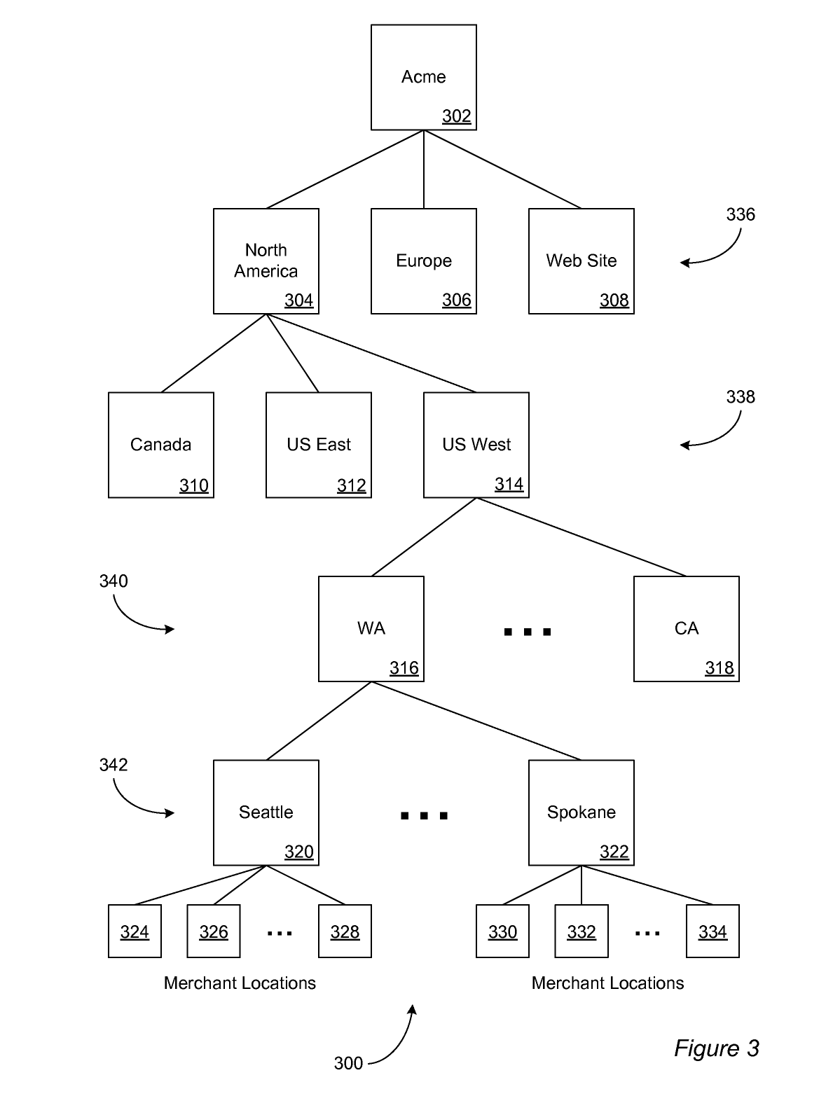

To facilitate mediated access to transaction data by authorized users, the payment processor 106 may incorporate a hierarchically mediated transaction data component. FIG. 2 depicts aspects of an example hierarchically mediated transaction data component 200 in accordance with at least one embodiment of the invention. The mediated transaction data component 200 may include a transaction database 202 accessible with a user interface 204 as mediated by one or more merchant structure hierarchies 206. An example merchant structure hierarchy is described below in more detail with reference to FIG. 3.

Authorized users may establish and update merchant structure hierarchies 206 for a variety of purposes including reporting, searching and decision management. The example depicted in FIG. 2 shows distinct hierarchies for each purpose, including multiple distinct reporting hierarchies 208, 210, a searching hierarchy 212 and a decision management hierarchy 214, however each embodiment of the invention is not so limited. As is conventional, ellipses are used to indicate a plurality of components. For example, the merchant structure hierarchies 206 may include any suitable number of reporting hierarchies 208, 210. Although not depicted in the example of FIG. 2, the merchant structure hierarchies 206 may also include any suitable number of searching hierarchies and decision management hierarchies. Changes to each hierarchy 208, 210, 212, 214 may be recorded such that active versions during historical intervals of time may be determined. For example, corresponding hierarchy histories 216, 218, 220, 222 may contain copies of inactive hierarchies along with indications of the time intervals during which the hierarchies were active. Alternatively, or in addition, the hierarchy histories 216, 218, 220, 222 may contain representations of hierarchy edits such that historical versions may be reconstructed as required. A particular version of a hierarchy 208, 210, 212, 214 may transition from active to inactive responsive to a set of one or more hierarchy editing operations. For example such operations may include creating, updating and deleting hierarchy nodes as well as creating, updating and deleting links between nodes. The editing of links between nodes may be constrained such that the linked nodes form a hierarchy.

The mediated transaction data component 200 may include a user database 224 identifying users who may be authorized to access transaction data, along with information that may be used to authenticate such users. The mediated transaction data component 200 may include a user authentication component 226 configured to authenticate users based on presented authentication credentials and in accordance with the information in the user database 224.

The user interface 204 may include any suitable user interface components including programmatic components such as an application programming interface (API) and a graphical user interface (GUI) component 228. For example, the user interface component 204 may include a web service API configured to receive and respond to requests from suitably configured clients (e.g., the clients 114, 116, 118, 120, 122, 124 of FIG. 1). A user-editable configuration file is an example of a user interface.

The hierarchies 206 may include one or more reporting hierarchies 208, 210. For example, each reporting hierarchy 208, 210 may classify, categorize and/or group transactions in the transaction database 202 in a manner suited to different users and/or user groups. Users concerned with day-to-day operations may specify a reporting hierarchy that emphasizes operational units and/or that reflects an organization's operational structure. Users concerned with financial performance may specify a reporting hierarchy that emphasizes financial units and/or that reflects an organization's financial structure. Different users may be authorized to access and/or process transaction data associated with different sub-hierarchies. For example, regional managers may have access to data for their respective regions, while a corporate accountant may have access to multiple regions. Root nodes of the sub-hierarchies may reference authorized users and/or access control lists specifying user permissions. Alternatively, or in addition, access control lists may reference sub-hierarchies for which specified users are authorized.

Requested reports may be generated by a reporting component 230 based on transaction data associated with sub-hierarchies for which requesting users are authorized. Hierarchies and/or sub-hierarchies may reference reporting templates, and the reporting component may generate reports in accordance with the reporting templates. For example, reporting templates may vary by region. Reporting hierarchies 208, 210 may reference merchant locations and/or merchant transaction association identifiers such as merchant terminal identifiers, merchant reference numbers and/or merchant account numbers. Accordingly, specifying a sub-hierarchy (e.g., by selecting a node of the hierarchy that is the root node of the sub-hierarchy) may corresponding to specifying a set of merchant locations and/or merchant transaction association identifiers (e.g., the set collectively referenced by the nodes of the sub-hierarchy). A request for a report may specify a sub-hierarchy, and the report may be generated based on the transactions associated with the corresponding set of merchant locations and/or merchant transaction association identifiers. The report may be based on additional data as well, for example, contextual data for transactions may be drawn from a merchant database.

The transaction database 202 may include transaction records (e.g., numbering millions, billions and more). In accordance with at least one embodiment of the invention, transaction data records may include a relatively small set of simple data fields. For example, the set of data fields may include a transaction identifier, a merchant or business reference number (e.g., determined by the merchant's bank), a date and/or time (“datetime” or “time stamp”) of the transaction, and a payment amount associated with the transaction. As another example, the set of data fields may further include a product identification code (e.g., a stock-keeping unit or SKU code) or description. As yet another example, the set of data fields may further include a transaction status code indicating an approval status of the transaction.

A merchant database 232 may include merchant records and/or data structures. For example, a merchant data structure may include a merchant name, a merchant identifier, a merchant reference number (e.g., as determined by the merchant's bank), locations associated with the merchant (e.g., physical retail locations) or a reference thereto, terminals associated with the merchant (e.g., physical merchant terminal devices) or a reference thereto, and an indication of the merchant's acquiring bank. Merchant locations, for example, as referenced by the hierarchies 208, 210, 212, 214, may each be associated with one or more terminals such as merchant terminal devices. For example, physical retail locations may be associated with several merchant terminal devices, point-of-sale devices and/or computing devices, as well as with one or more merchant web sites or portions of a web site. Merchant locations may correspond to merchant reference numbers.

The hierarchies 206 may further include one or more searching hierarchies such as the search hierarchy 212, for example, hierarchies that classify, categorize and/or group transactions in the transaction database 202 in a manner suited to users and/or user groups that conduct ad hoc searches of the transaction database 202 and/or searches designed to detect patterns, including anomalous patterns, of transactions with respect to time, location, amount and/or any suitable transaction attribute. Such users may include users tasked with detecting fraud and/or managing financial risk or profitability. A searching component 234 may receive and appropriately respond to search requests.

The hierarchies 206 may further include one or more decision management hierarchies such as the decision management hierarchy 214, for example, hierarchies that classify, categorize and/or group transactions in the transaction database 202 in a manner suited to users and/or user groups that conduct and/or facilitate decisions with respect to transaction approval. Such users may include users employed by the merchant to assist customers, users employed by the payment processor, issuer or acquirer to facilitate approval of appropriate transactions, and/or users employed by third-party service organizations tasked with performing part or all of such functions. Nodes of decision management hierarchies may reference decision management policies stored in a decision management database 236. Such policies may be applicable to the set of transactions referenced by the node. The policies may be provided as an informational reference to users tasked with decision management. Alternatively, or in addition, policies may contain rules that are enforced by a decision management component 238. The decision management component 238 may receive and appropriately respond to decision management requests.

FIG. 3 depicts aspects of an example mediation hierarchy 300. The mediation hierarchy 300 includes a root node 302 (“Acme”), several layers of intermediated nodes 304, 306, 308, 310, 312, 314, 316, 318, 320, 322, and a set of leaf nodes 324, 326, 328, 330, 332, 334 (“Merchant Locations”). In this example, the root node 302 corresponds to a business enterprise, and each intermediate layer 336, 338, 340, 342 generally corresponds to increasingly fine-grained geographical regions. The first layer beneath the root node 302 also includes a “Web Site” node 308 that isn't necessarily correlated with a particular geographical region. Although not shown in FIG. 3, the “Web Site” node 308 may itself have child nodes and/or sub-hierarchies that group transactions in accordance with the mediation purpose. Each node 304, 306, 308, 310, 312, 314, 316, 318, 320, 322 of an intermediate layer may be a root node of a sub-hierarchy. For example, the “North America” node 304 is a root node for the sub-hierarchy that includes the “US West” node 314, the “WA” node 316, the “Seattle” node 320 and the associated “Merchant Location” nodes 324, 326, 328, 330, 332, 334. The nodes 302, 304, 306, 308, 310, 312, 314, 316, 318, 320, 322, 324, 326, 328, 330, 332, 334 of the mediation hierarchy may include data structures that reference information related to the mediation purpose. For example, each node 302, 304, 306, 308, 310, 312, 314, 316, 318, 320, 322, 324, 326, 328, 330, 332, 334 may reference a set of authorized users, reporting templates, previous and/or popular searches, and/or decision management policies.

The description now turns to example procedures that may be performed in accordance with at least one embodiment of the invention. For example, the procedures may be performed by the hierarchically mediated transaction data component 200 of FIG. 2.

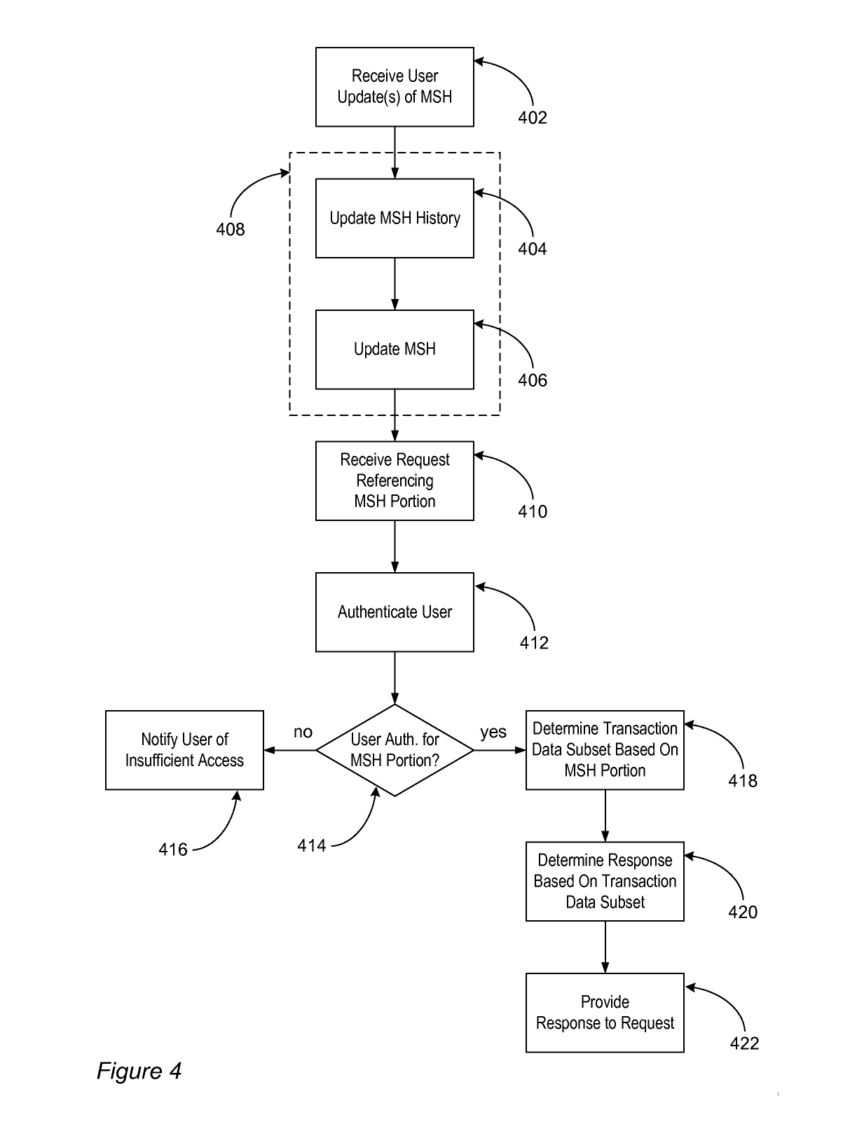

FIG. 4 depicts example steps for mediating transaction data in accordance with at least one embodiment of the invention. At step 402, one or more updates of a merchant structure hierarchy (MSH) may be received. For example, the hierarchically mediated transaction data component 200 of FIG. 2 may receive an update to the reporting hierarchy 208 responsive to user interaction with an editing component of the graphical user interface 228. At step 404, a history of the merchant structure hierarchy may be updated. For example, the update(s) received at step 402 may correspond to a committed edit of the reporting hierarchy 208, and the corresponding reporting hierarchy history 216 may be updated. At step 406, the merchant structure hierarchy may be updated in accordance with the update(s) received at step 402. Steps 404 and 406 are surrounded by a dashed line 408 in FIG. 4 to indicate that steps 404 and 406 may be integral. For example, updates to the reporting hierarchy 208 and its corresponding history 216 may occur as an atomic update operation. Alternatively, or in addition, the reporting hierarchy 208 and its corresponding history 216 may be incorporated into a single data structure that is updated by steps 404 and 406.

At step 410, a request may be received that references a portion of the merchant structure hierarchy. For example, a reporting, searching or decision management request may be received at the user interface 204 of the hierarchically mediated transaction data component 200 (FIG. 2) from a user. At step 412, the user may be authenticated, for example, by the user authentication component 226. At step 414, it may be determined whether the user is authorized to access the portion of the merchant structure hierarchy referenced by the request received at step 410. If not, a procedure incorporating step 414 may proceed to step 416 where the user is notified of insufficient access. Otherwise, the procedure may proceed to step 418. Although not shown in FIG. 4, there may be a similar authentication procedure prior to allowing updates of the merchant structure hierarchy at steps 404 and 406.

At step 418, a transaction data subset may be determined based at least in part on the portion of the merchant structure hierarchy referenced by the request. For example, the hierarchically mediated transaction data component 200 (FIG. 2) may determine a subset of the transaction database 202 that is associated with the referenced portion of the merchant structure hierarchy. Different portions of the transaction database 202 may be associated with different nodes in the referenced portion of the merchant structure hierarchy, and the hierarchically mediated transaction data component 200 may determine the subset of the transaction database 202 based on the referenced portions of the transaction database 202, for example, the subset may be based on and/or correspond to a union of the referenced portions of the transaction database 202. At step 420, a response to the request of step 410 may be determined based at least in part on the transaction data subset determined at step 418. For example, the reporting component 230, the searching component 234 and/or the decision management component 238 may determine the response to the request based at least in part on the transaction data subset. At step 422, the response determined at step 420 may be provided with respect to the request of step 410, for example, through the user interface 204.

FIG. 5 depicts further example steps for mediating transaction data access in accordance with at least one embodiment. At step 502, a node selection of a hierarchy (the “query hierarchy”) may be received. For example, a user of the hierarchically mediated transaction data component 200 (FIG. 2) may interact with the graphical user interface 228 to select one or more nodes of the hierarchy 300 of FIG. 3, and the hierarchically mediated transaction data component 200 may receive the selection. Alternatively, or in addition, the request of step 410 (FIG. 4) may include and/or reference such a selection, and the request may be received by the hierarchically mediated transaction data component 200. At step 504, a request including a time interval may be received. For example, the request of step 410 may further include and/or reference a time interval associated with the node selection. As described above, the node selection may be associated with a set of transactions, and the time interval may define a subset of the set of transactions associated with the node selection such as the subset of transactions having a transaction date within the time interval.

At step 506, it may be determined whether the time interval of step 504 includes one or more historical intervals. As described above, hierarchies, such as the hierarchy 300 of FIG. 3, may be edited by authorized users. Accordingly, particular hierarchies may be associated with a current version that is currently active and one or more historical versions that were active during corresponding historical intervals. At step 506, it may be determined, for example, whether the time interval of step 504 (sometimes called the “query interval”) includes one or more such historical intervals for the query hierarchy, that is, whether, given the time interval of step 504, only a current version of the query hierarchy need be considered for processing or whether one or more historical versions of the query hierarchy should also be considered for processing. Alternatively, the presence of historical intervals may be determined with respect to a sub-hierarchy of the query hierarchy defined by the node selection of step 502. If the time interval of step 504 does not include any such historical intervals, a procedure incorporating step 506 may progress to step 510 to process the request with respect to the current version of the query hierarchy, for example, as described above with reference to FIG. 4. If the time interval of step 504 does include one or more historical intervals, the procedure may progress to step 508.

At step 508, a next (e.g., a first) historical interval may be obtained, for example, from the hierarchy history 216, 218, 220, 222 (FIG. 2) corresponding to the query hierarchy. At step 512, the request of step 504 may be processed with respect to the corresponding historical version of the query hierarchy. At step 514, it may be determined whether there are more historical intervals associated with the query hierarchy or sub-hierachy for which the request has yet to be processed. If so, the procedure may progress to step 508 to obtain the next historical interval. Otherwise, the procedure may progress to step 510 to process the request with respect to the current version of the query hierarchy.

Processing the request of step 504 with respect to an historical version of the query hierarchy may correspond to processing the request with respect to the current version of the query hierarchy, for example, as described above with reference to FIG. 4. However, the sub-hierarchy of the query hierarchy defined by the node selection of step 502 may differ between versions. In addition to different permissions associations and/or different configurations with respect to reporting, searching and/or decision management functionality, the set of nodes in the sub-hierarchy and/or the links between the nodes may change between versions. It may even be the case that the node(s) selected at step 502 are not available for selection in one or more versions, in which case the request may be processed at step 512 with respect to a “null” sub-hierarchy, for example, it may be that no processing is performed for the corresponding time interval. The different versions of the query hierarchy may mediate disjoint sets of transactions corresponding to the different sub-intervals of time. Alternatively, or in addition, the different versions of the query hierarchy may mediate overlapping sets of transactions and/or a single set of transactions corresponding to the entire time interval indicated by the request.

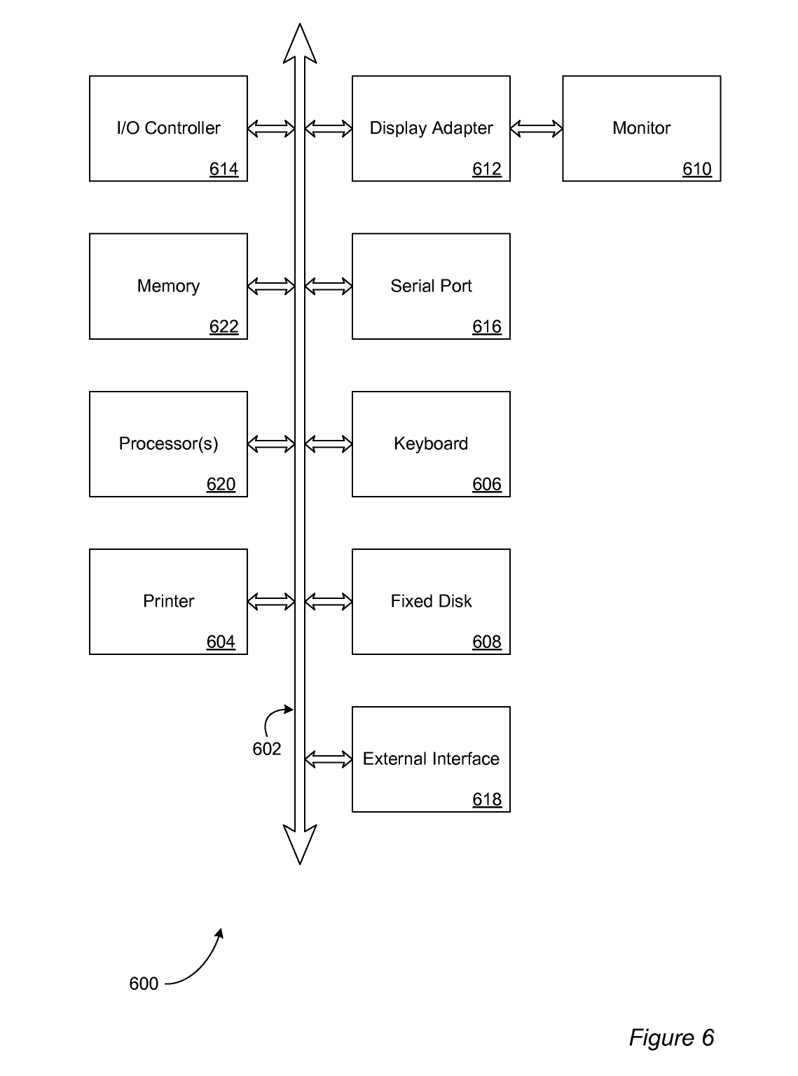

In accordance with at least some embodiments, the system, apparatus, methods, processes and/or operations for merchant structure hierarchies and/or the mediation of transaction data therewith may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, FIG. 6 depicts aspects of elements that may be present in a computer device and/or system 600 configured to implement a method and/or process in accordance with some embodiments of the present invention. The subsystems shown in FIG. 6 are interconnected via a system bus 602. Additional subsystems such as a printer 604, a keyboard 606, a fixed disk 608, a monitor 610, which is coupled to a display adapter 612. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to further devices and/or systems not shown in FIG. 6 including a wide area network such as the Internet, a mouse input device, and/or a scanner. The interconnection via the system bus 602 allows one or more processors 620 to communicate with each subsystem and to control the execution of instructions that may be stored in a system memory 622 and/or the fixed disk 608, as well as the exchange of information between subsystems. The system memory 622 and/or the fixed disk 608 may embody a tangible computer-readable medium.

The description now turns to various examples in accordance with at least one embodiment of the invention. The examples are numbered for ease of reference.

Example 1 is a method for mediating transaction data access with merchant structure hierarchies, the method including: maintaining, with one or more computers, a merchant structure hierarchy as specified at least in part with a user interface, the merchant structure hierarchy referencing at least a set of merchant locations that participate in the generation of a set of transaction data; receiving, at said one or more computers, a request for information with respect to the set of trans-action data, the request including at least one indication of at least one node of the merchant structure hierarchy; determining, with said one or more computers, a subset of the transaction data associated with the indicated at least one node of the merchant structure hierarchy; and providing, from said one or more computers, a response to the request for information based at least in part on the determined subset of the transaction data.

Example 2 is a method in accordance with Example 1, wherein the request for information includes an indication of a desired report and the response to the request includes the desired report based at least in part on the determined subset of the transaction data. Example 3 is a method in accordance with Example 1 or 2, wherein the request for information includes a set of search terms in addition to said at least one indication of said at least one node and the response to the request includes a set of search results based at least in part on the determined subset of the transaction data. Example 4 is a method in accordance with Example 1-2 or 3, wherein the request for information is associated with a decision management process and the response to the request includes information to facilitate the decision management process based at least in part on the determined subset of the transaction data.

Example 5 is a method for mediating transaction data access with merchant structure hierarchies, the method including: maintaining, with one or more computers, a merchant structure hierarchy as specified at least in part with a user interface, the merchant structure hierarchy referencing, at least, a set of merchant locations that participate in the generation of a set of transaction data and a set of users; authenticating, with said one or more computers, at least one of the set of users; receiving, at said one or more computers, a request for information with respect to the set of transaction data, the request originated by said at least one of the set of users and the request including at least one indication of at least one node of the merchant structure hierarchy; determining, with said one or more computers, whether a set of nodes of the merchant structure hierarchy for which said at least one of the set of users is authorized includes the indicated at least one node; and when said at least one of the set of users is so authorized, providing, from said one or more computers, a response to the request for information based at least in part on a subset of the transaction data associated with the indicated at least one node.

Example 6 is a method in accordance with Example 5, wherein the request for information includes an indication of a desired report and the response to the request includes the desired report based at least in part on the determined subset of the transaction data. Example 7 is a method in accordance with Example 5 or 6, wherein the request for information includes a set of search terms in addition to said at least one indication of said at least one node and the response to the request includes a set of search results based at least in part on the determined subset of the transaction data. Example 8 is a method in accordance with Example 5-6 or 7, wherein the request for information is associated with a decision management process and the response to the request includes information to facilitate the decision management process based at least in part on the determined subset of the transaction data.

Example 9 is a method for mediating transaction data access with merchant structure hierarchies, the method including: maintaining, with one or more computers, a merchant structure hierarchy having a plurality of versions each active during a corresponding interval of time, the merchant structure hierarchy referencing at least a set of merchant locations that participate in the generation of a set of transaction data; receiving, at said one or more computers, a request for information with respect to the set of transaction data, the request including at least one indication of at least one node of the merchant structure hierarchy and an indication of an interval of time; determining, with said one or more computers, a set of the plurality of versions of the merchant structure hierarchy that were active during the interval of time indicated by the request; determining, with said one or more computers, a subset of the transaction data associated with the indicated at least one node of the merchant structure hierarchy; and providing, from said one or more computers, a response to the request for information based at least in part on the determined subset of the transaction data as mediated by each of the determined set of the plurality of versions of the merchant structure hierarchy that were active during the interval of time indicated by the request.

Example 10 is a method in accordance with Example 9, wherein the request for information includes an indication of a desired report and the response to the request includes the desired report based at least in part on the determined subset of the transaction data as mediated by each of the determined set of the plurality of versions of the merchant structure hierarchy that were active during the interval of time indicated by the request. Example 11 is a method in accordance with Example 9 or 10, wherein the request for information includes a set of search terms in addition to said at least one indication of said at least one node and the response to the request includes a set of search results based at least in part on the determined subset of the transaction data as mediated by each of the determined set of the plurality of versions of the merchant structure hierarchy that were active during the interval of time indicated by the request. Example 12 is a method in accordance with Example 9-10 or 11, wherein the request for information is associated with a decision management process and the response to the request includes information to facilitate the decision management process based at least in part on the determined subset of the transaction data as mediated by each of the determined set of the plurality of versions of the merchant structure hierarchy that were active during the interval of time indicated by the request.

Example 13 is a method in accordance with Example 9-11 or 12, wherein determining the subset of the transaction data associated with the indicated at least one node of the merchant structure hierarchy includes determining a sub-hierarchy of the merchant structure hierarchy that includes each indicated node of the merchant structure hierarchy and determining the subset of the transaction data associated with each node in the sub-hierarchy. Example 14 is a method in accordance with Example 9-12 or 13, wherein each leaf node of the merchant structure hierarchy corresponds to at least one of the set of merchant locations and at least one leaf node of the merchant structure hierarchy corresponds to at least one merchant location that is independent of physical location. Example 15 is a method in accordance with Example 9-13 or 14, wherein the subset of the transaction data associated with the indicated at least one node of the merchant structure hierarchy is re-determined with respect to at least one of the determined set of the plurality of versions of the merchant structure hierarchy that were active during the interval of time indicated by the request.

Example 16 is a method in accordance with Example 9-14 or 15, wherein mediating the subset of the transaction data with the determined set of the plurality of versions of the merchant structure hierarchy that were active during the interval of time indicated by the request includes determining a plurality of subsets of the transaction data corresponding to the determined set of the plurality of versions of the merchant structure hierarchy. Example 17 is a method in accordance with Example 9-15 or 16, wherein mediating the subset of the transaction data with the determined set of the plurality of versions of the merchant structure hierarchy that were active during the interval of time indicated by the request includes determining a plurality of subsets of the set of merchant locations corresponding to the determined set of the plurality of versions of the merchant structure hierarchy and determining a plurality of subsets of the transaction data based at least in part on the determined plurality of subsets of the set of merchant locations. Example 18 is a method in accordance with Example 9-16 or 17, wherein mediating the subset of the transaction data with the determined set of the plurality of versions of the merchant structure hierarchy that were active during the interval of time indicated by the request includes determining a plurality of subintervals of the interval of time corresponding to the determined set of the plurality of versions of the merchant structure hierarchy and determining a plurality of subsets of the transaction data based at least in part on the determined plurality of subintervals of the interval of time.

Example 19 is a method in accordance with Example 9-17 or 18, wherein mediating the subset of the transaction data with the determined set of the plurality of versions of the merchant structure hierarchy that were active during the interval of time indicated by the request includes determining a plurality of categorizations of the subset of the transaction data corresponding to the determined set of the plurality of versions of the merchant structure hierarchy and providing the response to the request for information based at least in part on the subset of the transaction data and additional data associated with the determined plurality of categorizations. Example 20 is a method in accordance with Example 9-18 or 19, wherein mediating the subset of the transaction data with the determined set of the plurality of versions of the merchant structure hierarchy that were active during the interval of time indicated by the request includes re-determining access authorization with respect to each of the determined set of the plurality of versions of the merchant structure hierarchy that were active during the interval of time indicated by the request. Example 21 is a method in accordance with Example 9-19 or 20, wherein the plurality of versions of the merchant structure hierarchy were generated responsive to user interaction with a graphical user interface.

Example 22 is a method in accordance with Example 9, 11-20 or 21, wherein the request for information includes an indication of a desired report and the response to the request includes the desired report based at least in part on the determined subset of the transaction data as categorized by each of the determined set of the plurality of versions of the merchant structure hierarchy that were active during the interval of time indicated by the request. Example 23 is a method in accordance with Example 9, 11-21 or 22, wherein the request for information includes an indication of a desired report and the response to the request includes the desired report based at least in part on the determined subset of the transaction data as summarized according to each of the determined set of the plurality of versions of the merchant structure hierarchy that were active during the interval of time indicated by the request. Example 24 is a method in accordance with Example 23, wherein summarizing the transaction data includes summing transaction values of transactions in categories corresponding to nodes of the determined set of the plurality of versions of the merchant structure hierarchy that were active during the interval of time indicated by the request.

Example 25 is a method in accordance with Example 9-10, 12-23 or 24, wherein the request for information includes a set of search terms in addition to said at least one indication of said at least one node and the response to the request includes a set of search results based at least in part on the determined subset of the transaction data and non-transactional data corresponding to each of the determined set of the plurality of versions of the merchant structure hierarchy that were active during the interval of time indicated by the request.

Example 26 is a method in accordance with Example 9-24 or 25, wherein the transaction data relates to financial transactions on financial accounts that are issued by an issuer and the request for information is associated with a decision management process relating to approval of financial transactions. Example 27 is a method in accordance with Example 26, wherein mediating the determined subset of the transaction data with the determined set of the plurality of versions of the merchant structure hierarchy that were active during the interval of time indicated by the request improves an efficiency of the decision management process with respect to processing time. Example 28 is a method in accordance with Example 9-26 or 27, wherein the determined set of the plurality of versions of the merchant structure hierarchy that were active during the interval of time indicated by the request is associated with a plurality of subintervals of the interval of time and the plurality of subintervals are disjoint.

Example 29 is a system for mediating transaction data access with merchant structure hierarchies including one or more components collectively configured at least to perform a method in accordance with Example 9-27 or 28. Example 30 is a system in accordance with

Example 29, wherein the one or more components include one or more computers executing computer-executable instructions to perform the method. Example 31 is at least one computer-readable medium collectively having thereon computer-executable instructions that, when executed by one or more computers, causes the one or more computers to collectively perform a method in accordance with Example 9-27 or 28.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network. Each computer readable medium may be tangible and/or non-transitory.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Preferred embodiments of the invention are described herein, including the best mode known to the inventors for carrying out the invention. Variations of those preferred embodiments may become apparent to those of ordinary skill in the art upon reading the specification. The inventors expect skilled artisans to employ such variations as appropriate, and the inventors intend for the invention to be practiced otherwise than as explicitly described herein. Accordingly, embodiments of the invention include all modifications and equivalents of the subject matter recited in the following claims as permitted by applicable law.

What is claimed is:

1. A method for mediating transaction data access with merchant structure hierarchies, the method comprising:
maintaining, with one or more computers, a merchant structure hierarchy as specified at least in part with a user interface, the merchant structure hierarchy referencing at least a set of merchant locations that participate in the generation of a set of transaction data;
receiving, at said one or more computers, a request for information with respect to the set of transaction data, the request including at least one indication of at least one node of the merchant structure hierarchy;
determining, with said one or more computers, a subset of the transaction data associated with the indicated at least one node of the merchant structure hierarchy; and
providing, from said one or more computers, a response to the request for information based at least in part on the determined subset of the transaction data.

2. A method in accordance with claim 1, wherein the request for information comprises an indication of a desired report and the response to the request comprises the desired report based at least in part on the determined subset of the transaction data.

3. A method in accordance with claim 1, wherein the request for information comprises a set of search terms in addition to said at least one indication of said at least one node and the response to the request comprises a set of search results based at least in part on the determined subset of the transaction data.

4. A method in accordance with claim 1, wherein the request for information is associated with a decision management process and the response to the request comprises information to facilitate the decision management process based at least in part on the determined subset of the transaction data.

5. A method for mediating transaction data access with merchant structure hierarchies, the method comprising:
maintaining, with one or more computers, a merchant structure hierarchy as specified at least in part with a user interface, the merchant structure hierarchy referencing, at least, a set of merchant locations that participate in the generation of a set of transaction data and a set of users;
authenticating, with said one or more computers, at least one of the set of users;
receiving, at said one or more computers, a request for information with respect to the set of transaction data, the request originated by said at least one of the set of users and the request including at least one indication of at least one node of the merchant structure hierarchy;
determining, with said one or more computers, whether a set of nodes of the merchant structure hierarchy for which said at least one of the set of users is authorized includes the indicated at least one node; and
when said at least one of the set of users is so authorized, providing, from said one or more computers, a response to the request for information based at least in part on a subset of the transaction data associated with the indicated at least one node.

6. A method in accordance with claim 5, wherein the request for information comprises an indication of a desired report and the response to the request comprises the desired report based at least in part on the determined subset of the transaction data.

7. A method in accordance with claim 5, wherein the request for information comprises a set of search terms in addition to said at least one indication of said at least one node and the response to the request comprises a set of search results based at least in part on the determined subset of the transaction data.

8. A method in accordance with claim 5, wherein the request for information is associated with a decision management process and the response to the request comprises information to facilitate the decision management process based at least in part on the determined subset of the transaction data.

9. A method for mediating transaction data access with merchant structure hierarchies, the method comprising:
maintaining, with one or more computers, a merchant structure hierarchy having a plurality of versions each active during a corresponding interval of time, the merchant structure hierarchy referencing at least a set of merchant locations that participate in the generation of a set of transaction data;
receiving, at said one or more computers, a request for information with respect to the set of transaction data, the request including at least one indication of at least one node of the merchant structure hierarchy and an indication of an interval of time;
determining, with said one or more computers, a set of the plurality of versions of the merchant structure hierarchy that were active during the interval of time indicated by the request;
determining, with said one or more computers, a subset of the transaction data associated with the indicated at least one node of the merchant structure hierarchy; and
providing, from said one or more computers, a response to the request for information based at least in part on the determined subset of the transaction data as mediated by each of the determined set of the plurality of versions of the merchant structure hierarchy that were active during the interval of time indicated by the request.

10. A method in accordance with claim 9, wherein the request for information comprises an indication of a desired report and the response to the request comprises the desired report based at least in part on the determined subset of the transaction data as mediated by each of the determined set of the plurality of versions of the merchant structure hierarchy that were active during the interval of time indicated by the request.

11. A method in accordance with claim 9, wherein the request for information comprises a set of search terms in addition to said at least one indication of said at least one node and the response to the request comprises a set of search results based at least in part on the determined subset of the transaction data as mediated by each of the determined set of the plurality of versions of the merchant structure hierarchy that were active during the interval of time indicated by the request.

12. A method in accordance with claim 9, wherein the request for information is associated with a decision management process and the response to the request comprises information to facilitate the decision management process based at least in part on the determined subset of the transaction data as mediated by each of the determined set of the plurality of versions of the merchant structure hierarchy that were active during the interval of time indicated by the request.

13. A method in accordance with claim 9, wherein determining the subset of the transaction data associated with the indicated at least one node of the merchant structure hierarchy comprises determining a sub-hierarchy of the merchant structure hierarchy that includes each indicated node of the merchant structure hierarchy and determining the subset of the transaction data associated with each node in the sub-hierarchy.

14. A method in accordance with claim 9, wherein each leaf node of the merchant structure hierarchy corresponds to at least one of the set of merchant locations and at least one leaf node of the merchant structure hierarchy corresponds to at least one merchant location that is independent of physical location.

15. A method in accordance with claim 9, wherein the subset of the transaction data associated with the indicated at least one node of the merchant structure hierarchy is re-determined with respect to at least one of the determined set of the plurality of versions of the merchant structure hierarchy that were active during the interval of time indicated by the request.

16. A method in accordance with claim 9, wherein mediating the subset of the transaction data with the determined set of the plurality of versions of the merchant structure hierarchy that were active during the interval of time indicated by the request comprises determining a plurality of subsets of the transaction data corresponding to the determined set of the plurality of versions of the merchant structure hierarchy.

17. A method in accordance with claim 9, wherein mediating the subset of the transaction data with the determined set of the plurality of versions of the merchant structure hierarchy that were active during the interval of time indicated by the request comprises determining a plurality of subsets of the set of merchant locations corresponding to the determined set of the plurality of versions of the merchant structure hierarchy and determining a plurality of subsets of the transaction data based at least in part on the determined plurality of subsets of the set of merchant locations.

18. A method in accordance with claim 9, wherein mediating the subset of the transaction data with the determined set of the plurality of versions of the merchant structure hierarchy that were active during the interval of time indicated by the request comprises determining a plurality of sub-intervals of the interval of time corresponding to the determined set of the plurality of versions of the merchant structure hierarchy and determining a plurality of subsets of the transaction data based at least in part on the determined plurality of sub-intervals of the interval of time.

19. A method in accordance with claim 9, wherein mediating the subset of the transaction data with the determined set of the plurality of versions of the merchant structure hierarchy that were active during the interval of time indicated by the request comprises determining a plurality of categorizations of the subset of the transaction data corresponding to the determined set of the plurality of versions of the merchant structure hierarchy and providing the response to the request for information based at least in part on the subset of the transaction data and additional data associated with the determined plurality of categorizations.

20. A method in accordance with claim 9, wherein mediating the subset of the transaction data with the determined set of the plurality of versions of the merchant structure hierarchy that were active during the interval of time indicated by the request comprises re-determining access authorization with respect to each of the determined set of the plurality of versions of the merchant structure hierarchy that were active during the interval of time indicated by the request.
